(19) United States
(12) Patent Application Publication
(10) Pub. No.: US 2025/0070609 A1
(43) Pub. Date: Feb. 27, 2025

(54) ELECTRICAL WINDING

(71) Applicant: H3X TECHNOLOGIES INC., Louisville, CO (US)

(72) Inventors: Max Meyer Liben, Louisville, CO (US); Eric Paul Maciolek, Louisville, CO (US)

(21) Appl. No.: 18/726,186

(22) PCT Filed: Jan. 12, 2023
(86) PCT No.: PCT/US2023/010651

§ 371 Date: Jul. 2, 2024

Related U.S. Application Data
(60) Provisional application No. 63/299,106, filed on Jan. 13, 2022.

(51) Int. Cl. H02K 3/32; H02K 3/48

(52) U.S. Cl. CPC H02K 3/32; H02K 3/48

(57) ABSTRACT

An electrical winding including a single row of turns, with a first turn having a first turn insulation and a first plurality of conductors positioned within the first turn insulation. The first turn also includes a first conductor insulation coupled to each of the first plurality of conductors. The first conductor insulation has a first thickness of a first material, and the first turn insulation has a second thickness of a second material. The second thickness is larger than the first thickness.

### CROSS-REFERENCE TO RELATED APPLICATIONS

This application claims priority to and the benefit of U.S. Provisional Patent Application No. 63/299,106 filed Jan. 13, 2022 and is incorporated herein by reference in its entirety for all purposes.

### TECHNICAL FIELD

The present disclosure relates to electrical windings, and more particularly to electrical windings with variable insulation material and thickness.

### BACKGROUND

Conventional electrical windings include insulation that limits the performance of the electrical winding. For example, conventional insulation designs can create thermal performance limitations (e.g., when an electrical insulator also acts as thermal insulator), electrical performance limitations (e.g., when insulation is not able to stand off a large voltage), and/or power performance limitations (e.g., when insulation limits the conductor slot fill).

### SUMMARY

The disclosure provides, in one aspect, an electrical winding including a single row of turns, including a first turn. The first turn includes a first turn insulation, a first plurality of conductors positioned within the first turn insulation, a first conductor insulation coupled to each of the first plurality of conductors. The first conductor insulation has a first thickness, and the first turn insulation has a second thickness larger than the first thickness.

In some embodiments, the first turn insulation is a braid or serve; and wherein the braid or serve is impregnated with a thermoset resin.

In some embodiments, first turn insulation is a fused silica with a purity of at least 99.9%, Alumina, Beryllia, Boron Nitride, or Aluminum Nitride and the first conductor insulation is polyimide or polyether ether ketone based.

In some embodiments, the electrical winding has a radially inward portion and a radially outward portion, and wherein the first turn extends from the radially inward portion to the radially outward portion.

In some embodiments, at least one of the first plurality of conductors extends from the radially inward portion to the radially outward portion.

In some embodiments, a radial heat transfer path through the electrical winding passes through no more than two layers of the first turn insulation.

In some embodiments, the first plurality of conductors is transposed within the first turn.

In some embodiments, each of the first plurality of conductors has a diameter, and wherein a ratio of the first thickness to the diameter is within a range of 0.01 to 0.1.

In some embodiments, the electrical winding has a fill factor of at least 50%.

The disclosure provides, in another aspect, an electrical winding including a first turn with a first turn insulation, a first plurality of conductors positioned within the first turn insulation, and a first conductor insulation coupled to each of the first plurality of conductors. The first conductor insulation has a first thickness, and the first turn insulation has a second thickness larger than the first thickness. The first turn insulation is a braid, and the braid is impregnated with a thermoset resin.

In some embodiments, the first turn insulation is a fused silica with a purity of at least 99.9%, Alumina, Beryllia, Boron Nitride, or Aluminum Nitride.

In some embodiments, the first turn insulation has a thermal conductivity of at least 1 W/m-K.

In some embodiments, the first turn insulation has a thermal conductivity of at least 30 W/m-K.

In some embodiments, the first turn insulation has a dielectric strength less than 4000 V/mil.

In some embodiments, the first turn insulation has a dielectric strength within a range of 400 V/mil and 500 V/mil.

In some embodiments, space between the first plurality of conductors positioned within the first turn insulation is impregnated with the thermoset resin.

The disclosure provides, in another aspect, an electrical winding including a first turn with a first turn insulation made of a first material, a first plurality of conductors positioned within the first turn insulation, and a first conductor insulation coupled to each of the first plurality of conductors. The first conductor insulation made of a second material different than the first material. The first conductor insulation has a first thickness, and the first turn insulation has a second thickness larger than the first thickness.

In some embodiments, the first material is a fused silica with a purity of at least 99.9%, Alumina, Beryllia, Boron Nitride, or Aluminum Nitride.

In some embodiments, the second material is polyimide or polyether ether ketone based.

In some embodiments, the first conductor insulation is no more than single build.

In some embodiments, the electrical winding further includes a second turn with a second turn insulation and a second plurality of conductors positioned within the second turn insulation. In some embodiments, the electrical winding further includes a slot liner, wherein the first turn and the second turn are positioned within the slot liner.

In some embodiments, the slot liner is polyimide or polyether ether ketone based.

In some embodiments, the slot liner is a fabric of fibers made of fused silica, Alumina, Beryllia, Boron Nitride, or Aluminum Nitride.

The disclosure provides, in another aspect, an electrical winding including a slot liner with a first edge and a second edge. The electrical winding further includes a plurality of turns positioned within the slot liner. The plurality of turns define an outer perimeter with an air-gap portion. The first edge is coupled to the second edge at the air-gap portion such that the slot liner surrounds the outer perimeter with a uniform thickness except at the air-gap portion.

In some embodiments, the air-gap portion is a radially-inward surface of the plurality of turns.

In some embodiments, the first edge overlaps the second edge and is coupled to the second edge with an adhesive.

In some embodiments, a dielectric tape couples the first edge to the second edge.

In some embodiments, the slot liner is polyimide or polyether ether ketone based.

In some embodiments, the slot liner is a fabric of fibers made of fused silica, Alumina, Beryllia, Boron Nitride, or Aluminum Nitride.

In some embodiments, the slot liner has a thickness of no more than 20 mil.

In some embodiments, the winding does not include a slot wedge.

Other aspects of the disclosure will become apparent by consideration of the detailed description and accompanying drawings.

### BRIEF DESCRIPTION OF THE DRAWINGS

These and other features, aspects, and advantages of the present technology will become better understood with regards to the following drawings. The accompanying figures and examples are provided by way of illustration and not by way of limitation.

FIG. 1 is a cross-sectional view of an electric machine including electrical windings.

FIG. 2 is an enlarged partial view of FIG. 1.

FIG. 3 is a cross-sectional view of an electrical winding.

FIG. 4 is an enlarged partial view of FIG. 3.

FIG. 5 is a cross-sectional view of an electrical winding.

FIG. 6 is a schematic illustrating a transposition of conductors or conductors bundles along a length of a turn of an electrical winding.

Before any embodiments are explained in detail, it is to be understood that the invention is not limited in its application to the details of construction and the arrangement of components set forth in the following description or illustrated in the following drawings. The invention is capable of other embodiments and of being practiced or of being carried out in various ways.

### DETAILED DESCRIPTION

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent to those described herein can be used in practice or testing of the present disclosure. All publications, patent applications, patents and other references mentioned herein are incorporated by reference in their entirety. The materials, methods, and examples disclosed herein are illustrative only and not intended to be limiting.

The terms “comprise(s),” “include(s),” “having,” “has,” “can,” “contain(s),” and variants thereof, as used herein, are intended to be open-ended transitional phrases, terms, or words that do not preclude the possibility of additional acts or structures. The singular forms “a,” “an” and “the” include plural references unless the context clearly dictates otherwise. The present disclosure also contemplates other embodiments “comprising,” “consisting of” and “consisting essentially of,” the embodiments or elements presented herein, whether explicitly set forth or not.

For the recitation of numeric ranges herein, each intervening number there between with the same degree of precision is explicitly contemplated. For example, for the range of 6-9, the numbers 7 and 8 are contemplated in addition to 6 and 9, and for the range 6.0-7.0, the number 6.0, 6.1, 6.2, 6.3, 6.4, 6.5, 6.6, 6.7, 6.8, 6.9, and 7.0 are explicitly contemplated.

As used herein, the term “braid” refers to a filament, textile, or fiber that is woven or interlaced. An overbraid is a type of braid positioned around a cable, for example.

As used herein, the term “serve” refers to a filament, textile, or fiber wrapped circumferentially (e.g., unwoven) in a spiral around a cable.

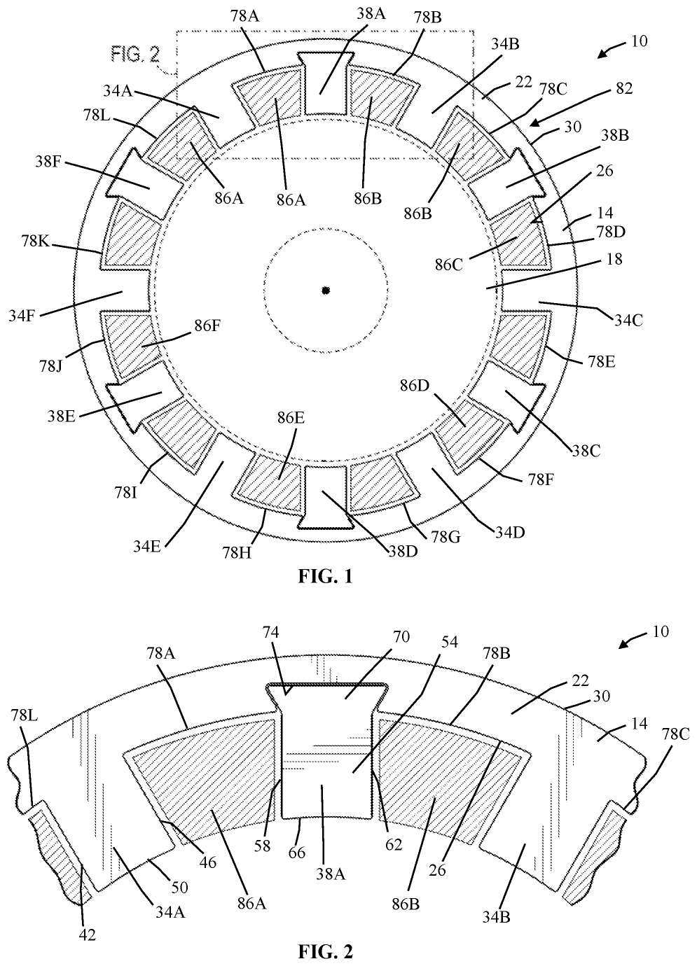

With reference to FIGS. 1 and 2, an electric motor 10 includes a stator 14 and a rotor 18. In the illustrated embodiment, the rotor 18 is positioned within the stator 14. In other embodiments, the rotor is positioned outside of the stator. The stator 14 of the electric motor 10 includes a yoke 22 (e.g., a back iron portion) with an inner surface 26 and an outer surface 30, a plurality of integral teeth 34A-34F, and a plurality of segmented teeth 38A-38F. In some embodiments, the yoke 22 is manufactured from stacked thin electrical steel laminations. In some embodiment, the electric motor 10 is a polyphase motor with a high-power density that is configured for high-demand applications such as driving an aircraft propeller or fan jet (e.g., an electric propulsion system). In some embodiments, the rotor 18 is an interior permanent magnet rotor. In other embodiment, the motor 10 is any other suitable motor topologies (e.g., induction motor, reluctance motor, synchronous motor, axial flux motor, transverse flux motor, etc.).

In the illustrated embodiment, the integral teeth 34A-34F alternates with the segmented teeth 38A-38F circumferentially around the yoke 22. For example, a first integral tooth 34A extends radially inward from the yoke 22 and the second integral tooth 34B extends radially inward from the yoke 22. Likewise, a first segmented tooth 38A extends radially inward from the yoke 22, and the first segmented tooth 38A is positioned circumferentially between the first integral tooth 34A and the second integral tooth 34B. A second segmented tooth 38B also extends radially inward from the yoke 22, and the second integral tooth 34B is positioned circumferentially between the first segmented tooth 38A and the second segmented tooth 38B. Unlike conventional fully segmented stators, the stator 14 described herein includes alternating integral teeth 34A-34F and segmented teeth 38A-38F.

With reference to FIG. 2, the first integral tooth 34A includes a first side surface 42, a second side surface 46, and a radially inward surface 50 that extends between the first side surface 42 and the second side surface 46. In the illustrated embodiment, the first side surface 42 and the second side surface 46 extend radially inward from the inner surface 26 of the yoke 22 to the radially inward surface 50. In some embodiments, the first side surface 42 and the second side surface 46 are parallel. In the illustrated embodiment, the radially inward surface 50 on the first integral tooth 34A is arcuate. In other words, the radially inward surface 50 is curved corresponding to the curvature of the rotor 18. In some embodiments, the second integral tooth 34B and the other integral teeth 34C, 34D, 34E, 34F are structurally identical to the first integral tooth 34A.

With continued reference to FIG. 2, the first segmented tooth 38A includes an extending portion 54 that extends from the inner surface 26 of the yoke 22. The extending portion 54 includes side surfaces 58, 62 and a radially inward surface 66 extending between the side surfaces 58, 62. In the illustrated embodiment, the radially inward surface 66 is arcuate and the side surfaces 58, 62 are parallel. In some embodiments, the first segmented tooth 38A includes a connection portion 70 that is received within a corresponding slot 74 formed in the yoke 22. In the illustrated embodiment, the connection portion 70 is dovetail shaped. In other words, the dovetail connection portion 70 of the segmented tooth 38A is received within a corresponding slot 74 formed in the yoke 22. In other embodiments, the connection portion 70 is any suitable mechanical interface (e.g., rail and slot). In other embodiments, the segmented tooth 38A includes no connection portion but rather abuts directly against the inner surface 26 of the yoke 22. In some embodiments, the second segmented tooth 38B and the other segmented teeth 38C, 38D, 38E, 38F are structurally identical to the first segmented tooth 38A.

In the illustrated embodiment, a plurality of slots 78A-78L (e.g., winding slots) is defined between adjacent integral teeth 34A-34F and segmented teeth 38A-38F. In the illustrated embodiment, there are twelve winding slots 78A-78L. For example, the winding slot 78A is at least partially defined by the inner surface 26 of the yoke 22, the side surface 46 of the integral tooth 34A, and the side surface 58 of the segmented tooth 38A

The electric motor 10 includes a stator winding assembly 82. In some embodiments, the stator winding assembly 82 includes six windings 86A-86F (coils) that are wye connected using a coil pattern of “AbCaBc” (where upper/lower case indicates coil current direction). As such, each phase of the stator winding assembly 82 includes two radially opposite coils.

In some embodiments, a first stator winding 86A is wound around the first integral tooth 34A and a second stator winding 86B is wound around the second integral tooth 34B, and the first segmented tooth 38A is positioned between the first winding 86A and the second winding 86B. In some embodiments, no winding is wound around the segmented teeth 38A-38F. In other words, every other stator tooth is wound in the illustrated embodiment, with six wound teeth (i.e., the six integral teeth 34A-34F) and six un-wound teeth (i.e., the six segmented teeth 38A-38F).

Advantageously, the first winding 86A can easily be inserted onto the first integral tooth 34A after the first winding 86A is formed and while the first segmented tooth 38A is removed from the yoke 22. After the first winding 86A is inserted around the first integral tooth 34A and the second winding 86B is inserted around the second integral tooth 34B, the first segmented tooth 38A is then inserted and coupled to the yoke 22. As such, the first segmented tooth 38A acts to retain the first winding 86A and the second winding 86B in position once the segmented tooth 38A is coupled to the yoke 22. In other words, the segmented teeth 38A-38F secure the plurality of windings 86A-86F in the slots 78A-78L and on to the integral teeth 34A-34F.

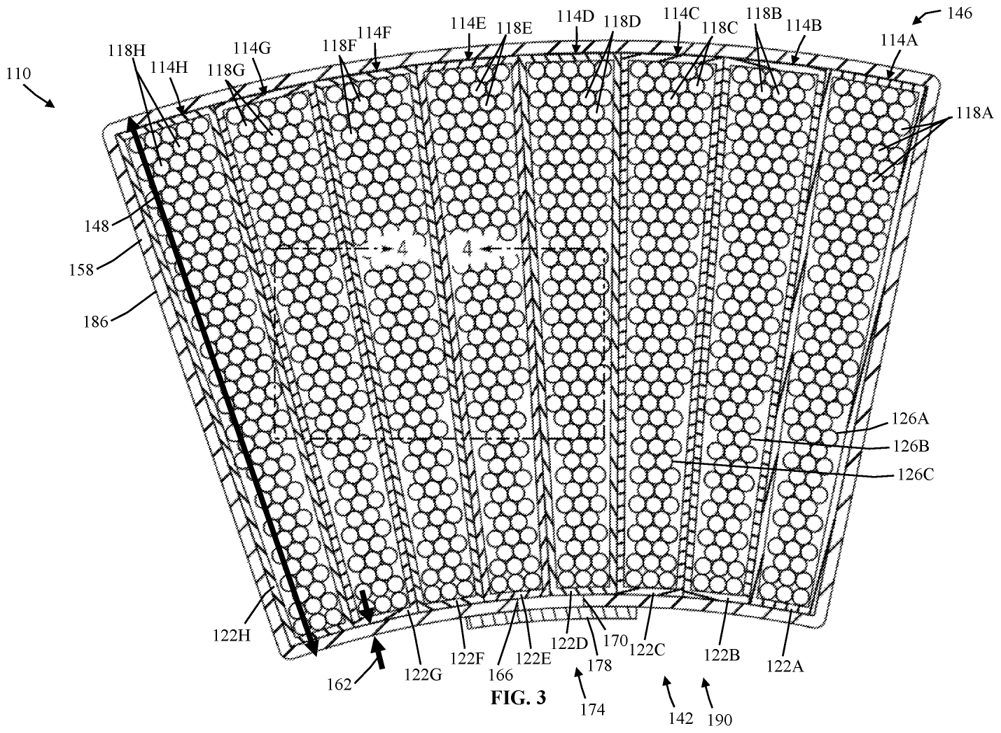

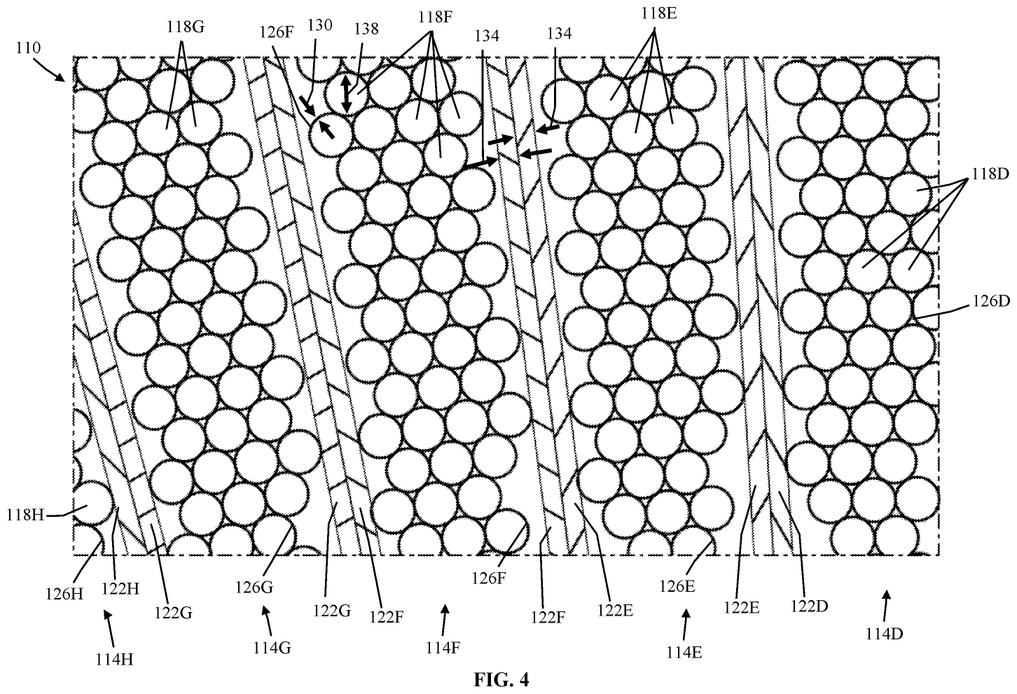

With reference to FIGS. 3 and 4, an electrical winding 110 (e.g., a winding, a coil) is illustrated. In some embodiments, the winding 110 is one or more of the stator windings (86A-86F) of the stator winding assembly 82. Any of the windings described herein may be used in some embodiments as part of the stator winding assembly 82. Likewise, any of the windings described herein may be used in some embodiments as part of a rotor winding assembly.

The winding 110 includes a plurality of turns 114A-114H. In the illustrated embodiment, the winding 110 includes eight turns 114A-114H with a first plurality of conductors 118A (e.g., strands) in the first turn 114A, a second plurality of conductors 118B in the second turn 114B, a third plurality of conductors 118C in the third turn 114C, a fourth plurality of conductors 118D in the fourth turn 114D, a fifth plurality of conductors 118E in the fifth turn 114E, a sixth plurality of conductors 118F in the sixth turn 114F, a seventh plurality of conductors 118G in the seventh turn 114G, and an eighth plurality of conductors 118H in the eighth turn 114H. In the illustrated embodiment, each of the turns 114A-114H includes the same number of conductors within the turns. In the illustrated embodiment, each turn 114A-114H includes 126 conductors positioned therein. In other embodiments, different turns have a different number of conductors within them.

Each of the turns 114A-114H has a turn insulation 122A-122H and the pluralities of conductors 118A-118H are positioned within the respective turn insulation 122A-122H. For example, the first turn 114A includes the first turn insulation 122A and the first plurality of conductors 118A are positioned within the first turn insulation 122A. Likewise, the second turn 114B includes the second turn insulation 122B and the second plurality of conductors 118B are positioned within the second turn insulation 122B. In some embodiments, the conductors within a turn are twisted, transposed, and/or compacted wire.

Advantageously, the pluralities of conductors 118A-118H reduces AC losses. For example, when an electric motor becomes magnetically saturated, magnetic flux fringes out of the magnetic cores and enters the current-carrying conductors. As individually insulated wires get smaller, the AC losses due to skin effect (current traveling only on the outermost surfaces of the conductor) and proximity effect (current bunching up on one side of the conductor due to flux lines crossing the conductor) are reduced. In some embodiments, the pluralities of conductors 118A-118H create a high conductor fill factor with respect to the cross-sectional area of the winding 110. In some embodiments, the winding 110 disclosed herein has a fill factor (area percentage of conductor carrying material to an area of the winding) of at least 50% with a bus voltage of approximately 800 V. In some embodiments, the fill factor is approximately 80%.

Each of the conductors in the pluralities of conductors 118A-118H has a conductor insulation 126A-126H coupled to the conductor. For example, the first turn 114A includes a first conductor insulation 126A coupled to each of the first plurality of conductors 118A. Likewise, the second turn 114B includes a second conductor insulation 126B coupled to each of the second plurality of conductors 118B. In some embodiments, the conductor insulation 126A-126H is polyimide-based. In one embodiment, the polyimide-based insulation is a polyamide-imide. In other embodiments, the conductor insulation 126A-126H is polyether ether ketone based (PEEK-based). In some embodiments, the insulation is any suitable polyaryletherketone. In some embodiments, the insulator is a polyimide or PEEK formula that is filled with a filler to improve thermal conductivity. In some embodiments, the conductor insulation 126A-126H is no more than a single build thickness (as per NEMA standard MW1000). In some embodiments, the conductor insulation 126A-126H is less than a single build thickness.

Conductors within a given turn are electrically coupled in parallel, but small voltage differences are generated between adjacent conductors because of high frequency eddy currents resulting from fringing magnetic flux. The voltage differences between adjacent conductors are typically relatively small (e.g., on the order of tens of volts), and so the conductor insulation 126A-126H can be extraordinarily thin and still standoff the voltage. Although conventional conductor insulation is thin, the conventional conductors themselves are also small in diameter, and so the volume fraction of the turn or bundle that consists of conductor insulation in conventional designs can be significant. Advantageously, the electrical winding 110 uses extremely thin conductor insulation 126A-126H to maximize the available space for the current-carrying conductors 118A-118H (e.g., copper conductors, aluminum conductors, etc.) while simultaneously minimizing the thermal resistance. In some embodiments, the conductor insulation 126A-126H is single build high-temperature, high-thermal conductivity polyimide (polyimide enamel). In some embodiments, the conductor insulation is uniform for each of the turns 114A-114H (same conductor insulation thickness and material). In other embodiments, the conductor insulation varies (e.g., in thickness and/or material) between turns 114A-114H.

In the illustrated embodiment, the turn insulation 122A-122H (e.g., the first turn insulation, second turn insulation) is a thermally conductive braid (e.g., woven textiles, woven fibers) or serve (e.g., circumferentially wound textile or fiber). The braid or serve of turn insulation 122A-122H is mechanically flexible and permeable to liquid monomer or prepolymer. In some embodiment, the turn insulation 122A-122H is a ceramic (e.g., Alumina, Beryllia, Boron Nitride, Aluminum Nitride, etc.) or glass (e.g., fused silica or fused quartz). In some embodiments, the fused silica has a purity of at least 99.9%. In some embodiments, the turn insulation 122A-122H has a thermal conductivity of at least 1 W/m-K. In other embodiments, the turn insulation 122A-122H has a thermal conductivity of at least 30 W/m-K. For example, Alumina has a thermal conductivity of approximately 30 W/m-K at ambient temperatures, and approximately 15 W/m-K at elevated temperatures (e.g., 220-260° C.). In contrast, conventional insulation materials have a low thermal conductivity of less than 0.2 W/m-K.

In some embodiments, the turn insulation 122A-122H is made of a first material and the conductor insulation 126A-126H is made of a second material different than the first material. For example, the first turn insulation 114A is made of a first material (e.g., a fused silica, Alumina, Beryllia, Boron Nitride, Aluminum Nitride, etc.) and the first conductor insulation 126A is made of a second material (e.g., polyimide, polyamide-imide, PEEK, etc.). As such, in some embodiments, different insulating materials are present within the same electrical winding.

In some embodiments, the turn insulation 122A-122H has a dielectric strength less than 5000 V/mil (Volts per thousandth of an inch). In other embodiments, the turn insulation 122A-122H has a dielectric strength within a range of approximately 400 V/mil and approximately 500 V/mil. The insulation disclosed herein is designed to be partial discharge (PD) resistant, which requires thicker insulation than would be predicted based on the dielectric strength (V/mil) of the material alone. This is because PD is more a function of the dielectric constant and thickness of the insulation materials and is independent of the dielectric strength. Since the PD behavior can drive the required insulation thickness, materials that have higher thermal conductivity (and generally lower dielectric strength) are a better choice for relatively thick insulation. Alumina, Beryllia, Boron Nitride, Aluminum Nitride, and fused silica all fall into this category, with dielectric strengths around 400-500 V/mil compared to polyimide which is in the 4000-5000 V/mil range.

In some embodiments, the turn insulation is permeable, high-purity fused quartz (silica), Alumina, Beryllia, Boron Nitride, or Aluminum Nitride fibers woven into a braid or wound into a serve. Because each turn 114A-114H has the turn insulation 122A-122H surrounding it, there are two layers of turn insulation between the conductors of adjacent turns. In other words, the turn-to-turn insulation includes two layers of turn insulation 122A-122H. For example, there are two layers of turn insulation 122A and 122B positioned between the first turn 114A and the second turn 114B. Likewise, with reference to FIG. 4, there are two layers of turn insulation 122E and 122F positioned between the fifth turn 114E and the sixth turn 114F.

When voltage is applied to the winding 110 with a fast rise time, parasitic capacitance within the winding 110 can prevent the voltage from evenly distributing instantaneously amongst the turns 114A-114H. In other words, the voltage takes a small but tangible amount of time to propagate from the winding leads into the rest of the turns. As a result, during that transition time it is possible to have the full applied voltage across a single layer of turn-to-turn insulation. With the proliferation of wide bandgap (WBG) power switching devices such as Silicon Carbide and Gallium Nitride, voltage switching rise times are becoming orders of magnitude shorter, and the resultant change in voltage over time (dV/dt) causes high stress on turn insulation. Therefore, the turn insulation 122A-122H in the illustrated embodiment is thicker than the conductor insulation 126A-126H such that the turn insulation 122A-122H can stand off the maximum applied voltage between, for example, the first turn 114A and the second turn 114B.

With reference to FIG. 4, in the illustrated embodiment, the conductor insulation 126A-126H has a first thickness 130 and the turn insulation 122A-122H has a second thickness 134 larger than the first thickness 130. In other words, the conductor insulation 126A-126H around each individual copper conductor is smaller than the turn insulation 122A-122H around each of the turns 114A-114H.

Conventional windings use the conductor insulation also as the turn insulation. However, because of high voltage stress between turns in windings driven by WBG switching devices, for example, the conductor insulation in conventional windings (which is used as the turn insulation) must be thicker to withstand the voltage transients across turns. As a result, conventional windings require “triple” or “quad” enamel build-up on the individual conductors, instead of thinner, “single build” wire enamel. As such, conventional winding can have a large volume fraction of insulation in a coil bundle, leaving less room for current-carrying conductors and resulting in higher thermal resistance through the bundle.

Thicker conductor insulation (wire enamels) is not practical for high performance applications because of, among other things, the thermal constraints. Electrically insulating materials can also be thermally insulating. A high voltage winding needs a certain dielectric strength between current-carrying conductors at high potentials and other nearby conductors sitting at different potentials. From a thermal performance perspective, an “ideal” high voltage insulator is a minimum thickness of a thermally conductive material that satisfies the dielectric requirements (including both the reduction in dielectric strength due to aging and resistance to partial discharge). The minimum required thickness is a function of the voltage magnitude that needs to be stood off between electrical conductors on either side of the insulation.

In particular, conventional insulation systems result in turn insulation that creates significant thermal barriers to heat transfer. For example, conventional insulations systems include many layers of thick Nomex paper or Mica tape. Conventional wrapping of turns with overlapping strips of tape insulation is inefficient and can create uneven surfaces that varies in thickness (e.g., from 1× to 2× thickness). Variations in thickness reduces the effective thermal conductance between turns. Some conventional wrapping of turns is also non-permeable, such that liquid monomer or prepolymer is unable to penetrate the turn and into the space between individual conductors.

With continued reference to FIG. 4, the electrical winding 110 disclosed herein has different insulation thickness for the individual conductors 118A-118H and the turns 114A-114H. In other words, the first thickness 130 of the conductor insulation 126A-126H is different than the second thickness 134 of the turn insulation 122A-122H. Advantageously, the conductor insulation 126A-126H is designed as the thinnest available (e.g., single build or less), and the turn insulation 122A-122H is as thick as electrically necessary. This minimizes thermal resistance and maximizes space available for copper current-carrying conductors in the winding 110. In the illustrated embodiment, each of the first plurality of conductors 118A-118H has a diameter 138 (e.g., the diameter of the current-carrying conductor) and a ratio of the first thickness 130 to the diameter 138 is within a range of approximately 0.01 to approximately 0.1. In some embodiments, the ratio of the first thickness 130 to the diameter 138 is within a arrange of approximately 0.05 to approximately 0.15.

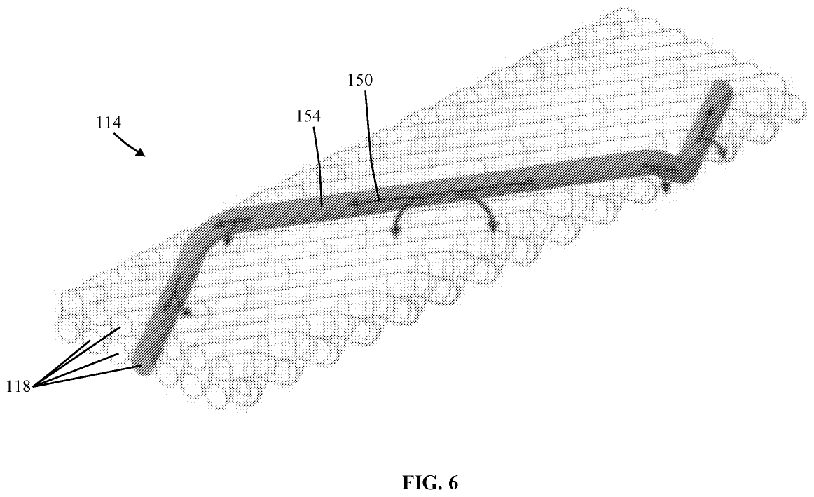

In the illustrated embodiment, the conductors 118A-118H are transposed within a given turns 114A-114H. For example, the first plurality of conductors 118A is transposed within the first turn 114A. In other words, the position of a given conductor is different at different locations along the length of a turn. In some embodiments, the conductors within a turn include bundles of conductors transposed, where each of the bundles themselves includes transposed conductors. FIG. 6 illustrates one example of transposition of conductors 118 (or the bundles of conductors) throughout the length of a turn 114.

With continued reference to FIG. 3, the electrical winding 110 includes a single row of turns 114A-114H. In other words, the winding 110 is arranged in a “1×N” configuration, where N is the number of turns. In the illustrated embodiment, the winding 110 is a single row of eight turns 114A-114H (1×8). The electrical winding 110 has a radially inward portion 142 and a radially outward portion 146, and the first turn 114A extends from the radially inward portion 142 to the radially outward portion 146. In other words, each turn extends approximately the entire radial distance of the winding 110. By arranging the turns in a single row configuration (a “1×N” configuration), the thermal resistance from the turn insulation 122A-122H is minimized in a direction (e.g., the radial direction). In contrast, conventional windings with a multiple row, multiple column turn configuration (a “M×N” arrangement), multiple layers of turn insulation create thermal barriers in every direction. In some embodiments, the winding 110 includes a radial heat transfer path 148 through the winding 110 that passes through no more than two layers of the turn insulation (e.g., a radially inward layer and a radially outward layer of the first turn insulation 122A).

With reference to FIG. 6, because of the conductors being transposed within a given turn, there is a diagonal three-dimensional heat transfer path 150 for undesired thermal energy (e.g., waste heat) to flow through the conductors from the radially inward position 142 to the radially outward position 146. For example, at least one of the conductors 154 extends from the radially inward portion 142 to the radially outward portion 146 and this single conductor 154 therefore represents a radial and axial heat transfer path 150 (a three-dimensional heat transfer path) through the electrical winding 110. In other words, the single conductor (made of copper with high thermal conductance) can transfer heat from a radially inward portion of the winding to a radially outward portion of the winding as the single conductor transposes along the axial length of the turn.

The conductors 118A-118H are made of a thermally conductive material (e.g., copper) that is approximately 100 times more thermally conductive than an effective thermal conductivity of the radial heat transfer path 148 through multiple conductors and insulation layers. In the illustrated embodiment, the three-dimensional heat transfer path 150 along the conductor diagonal is within a range of approximately 3 times to approximately 20 times longer than the in-plane or two-dimensional radial path 148 through the winding 110. As such, the effective thermal resistance along the three-dimensional radial heat transfer path 150 is approximately 3/100 to 20/100 times the two-dimensional radial path 154.

As described herein, arranging the winding 110 as a single row of turns (e.g., a 1×N configuration) with transposed conductors along the turn provides a variety of advantages. First, a single row of turns simplifies the winding manufacturing process. Second, a single row of turns creates low thermal resistance radially, because the radial heat transfer path 148 is through individual conductors in a turn and not through multiple layers of turn insulation. Third, because the conductors are transposed within a given turn, the diagonal three-dimensional heat transfer path 150 allows waste heat to efficiently flow through the individual conductors from a radially inward position to a radially outward position.

In some embodiments, the electrical winding 110 is impregnated with a thermoset resin. As used herein, the term “thermoset resin” refers to any resin that is obtained by hardening or curing a liquid monomer or prepolymer. In some embodiments, the thermoset resin is an epoxy, a bismaleimide, a polyimide, a phenolic resin, a cyanate ester resin, a vinyl ester resin, a polybismaleimide, a polybenzoxazine, or other suitable thermoset resin. In the illustrated embodiment, the braid of turn insulation 122A-122H is permeable and is impregnated with the thermoset resin. As such, the thermoset resin can penetrate each turn 114A-114H and fill any space remaining between the individual conductors 118A-118H. For example, in the illustrated embodiment, space between the first plurality of conductors 118A positioned within the first turn insulation 114A is impregnated with the thermoset resin. In some embodiments, the thermoset resin is a high thermal conductivity dielectric encapsulant.

With continued reference to FIG. 3, the electrical winding 110 further includes a slot liner 158 to provide ground wall insulation (phase to ground insulation). In the illustrated embodiment, each of the turns 114A-114H are positioned within the slot liner 158. In some embodiments, the slot liner 158 is sheet of polyimide based (e.g., polyamide-imide) or PEEK based material. In other embodiments, the slot liner 158 is a fabric of woven fibers made of fused silica, Alumina, Beryllia, Boron Nitride, or Aluminum Nitride. In some embodiments, the slot liner 158 is permeable and impregnated with the thermoset resin. In the illustrated embodiment, the slot liner 158 has a thickness 162 within a range of approximately 2 mil (thousandth of an inch) to approximately 20 mil.

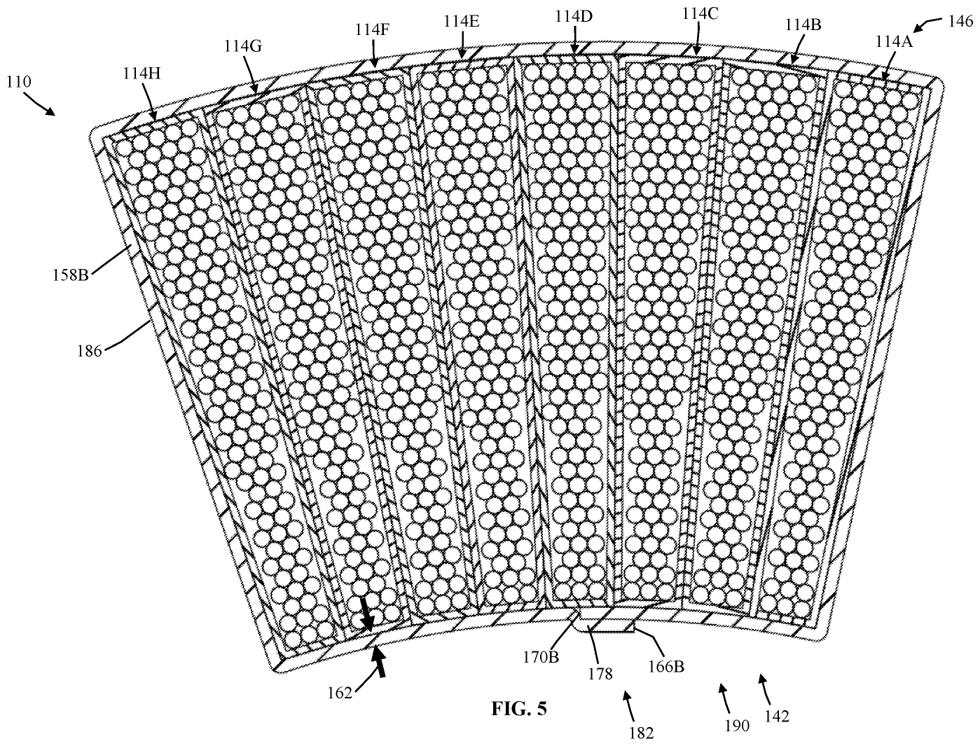

The slot liner 166 includes a first edge 166 and a second edge 170. The slot liner 158 is at least partially wrapped around the plurality of turns 114A-114H. The first edge 166 is coupled to the second edge 170 at a joint 174. With reference to FIG. 3, the joint 174 includes a tape 178 (e.g., a dielectric tape) that couples the first edge 166 to the second edge 170. With reference to FIG. 5, a joint 182 according to another embodiment couples the first edge 166B to the second edge 170B. In the joint 182 of FIG. 5, the first edge 166B overlaps the second edge 166B and is coupled to the second edge 166B with an adhesive. In other words, the slot liner 158B of FIG. 5 is layered on top of itself at the joint 182. In either embodiment, the slot liner (e.g., 158, 182) provides full dielectric coverage around the turns 114A-114H without gaps.

With continued reference to FIG. 3, turns 114A-114H are positioned within the slot liner 158 define an outer perimeter 186 with an air-gap portion 190. In the illustrated embodiment, the air-gap portion 190 is on a radially-inward facing surface of the plurality of turns 114A-114H. In other embodiments, the air-gap portion is on a radially-outward facing surface of the winding, an axially facing surface, or a transverse surface. The joint 174 is located at the air-gap portion 190 such that the slot liner 158 surrounds the outer perimeter 186 of the turns 114A-114H with a uniform thickness everywhere except at the air-gap portion 190. In other words, a single uniform layer of slot liner 158 is present around the winding 110 except for at the joint 174 where there is two layers of thickness created by the slot liner 158 and the tape 178. As such, with the winding 110 installed in a core (e.g., stator or rotor), the slot liner 158 has a uniform thickness (e.g., 162) (a single layer) between the core and the turns 114A-114H.

The winding 110 is placed in physical contact with grounded metallic components (e.g., a magnetic stator core constructed from steel laminations or some other metallic or conductive housing). During operation, portions of the winding 110 are brought up to the high voltage bus potential (plus any ringing or overshoot from the power switches). As such, the slot liner 158 is designed to withstand this large voltage. Conventional windings use a laminate of Nomex-Kapton-Nomex for ground wall insulation because it is mechanically resilient, and the mechanical resilience of the slot liner in conventional windings is necessary because of the large mechanical stresses imposed as the winding is wound (e.g., wound around a stator tooth). Those mechanical stresses are not imposed on the winding 110 disclosed herein during manufacturing and/or assembly. As a result, the winding 110 creates minimal mechanical strain on the slot liner 158, so a relatively thin, high thermal conductivity polyimide sheet, PEEK sheet, or woven fabric sheet is advantageously usable for ground wall insulation.

With continued reference to FIG. 3, the slot liner 158 protects the top and two sides of the winding 110. In some embodiments, the slot liner 158 separates the top side of the winding from a stator back iron, and separates each of the winding sides from a stator tooth. The slot liner 158 also wraps around a bottom side of the winding 110 (e.g., the air-gap portion 190). It is important to also position the slot liner 158 on the air-gap portion 190 because air-gaps are small, and rotors are typically grounded. Conventional windings utilize a slot wedge to separate the winding from, for example, a rotor across an air-gap. In the illustrated embodiment, the winding 110 does not include a slot wedge. A conventional slot wedge takes ups valuable area from the winding (reducing the copper fill factor, etc.). By removing the conventional slot wedge, the winding 100 completely fills the entire slot area with a maximum amount of current-carrying conductors. In addition, a conventional slot wedge is typically used to keep a winding in position within a stator slot. However, in the illustrated embodiment, a conventional slot wedge is not needed to keep the winding 110 is position in the slots 78A-78L because the stator 14 includes segmented teeth 38A-38F.

The present disclosure provides an electrical winding with a 1×N arrangement of formed wire bundles and an insulation system that includes different insulation thicknesses and/or materials for conductor insulation (within a single coil turn, aka bundle), turn insulation, and coil-ground insulation (e.g., slot liner). The winding disclosed herein maximizes the fill factor for the copper current-carrying conductors (minimizing the electrical resistance) and minimizes the thermal resistance through the winding to the stator (maximizing the thermally permissible continuous coil current and motor output power). In some embodiments, the winding 110 is operated with an applied voltage of at least 800 V. In some embodiments, the voltage applied to the winding 110 is switched at as much as 80 kHz. In some embodiments, the voltage rise time applied to the winding is as low as 10 ns, corresponding to a change in applied voltage per change in time as high as approximately 100 V/ns. In some embodiments, the winding 110 is continuously operable at a temperature of at least 260° C. These metrics for the winding 110 are significant improvements over the capabilities of conventional winding designs.

EXAMPLE. In one example, the electrical winding has a thermal conductivity in a circumferential direction within a range of approximately 3 to approximately 4 W/m-K. The electrical winding also has a thermal conductivity in a radial direction within a range of approximately 10 to approximately 14 W/m-K. In addition, the electrical winding advantageously has improved partial discharge behavior with a measured repetitive partial discharge inception voltage greater than approximately 1200 V at maximum rated temperature and all designated pressures. Conventional windings have partial discharge behavior that degrades at higher winding temperatures and at low ambient pressures found at higher altitude. Also, the electrical winding advantageously has improved current density with a measured thermally continuous current density within a range of approximately 30 to approximately 50 A/mm².

Some embodiments described herein refer to a winding as a stator winding in a non-limiting manner. In other embodiment, the winding is a rotor winding, an axial flux winding, or a transverse flux winding, for example. Likewise, example windings illustrated and described herein include a certain number of turns and segments to provide non-limiting examples. In other embodiments, the winding includes any suitable number of turns and/or segments.

In some embodiments, the turn insulation can also be used as phase insulation if there are windings from each phase in close physical proximity. Because the turn insulation is sized for partial-discharge resistance with the full applied voltage between one turn and an adjacent turn during a switching transient, the phase insulation can be sized similar to the turn insulation.

Various features and advantages are set forth in the following claims.

What is claimed is:

1. An electrical winding comprising:
a single row of turns, including a first turn with:
a first turn insulation;
a first plurality of conductors positioned within the first turn insulation; and
a first conductor insulation coupled to each of the first plurality of conductors;
wherein the first conductor insulation has a first thickness, and the first turn insulation has a second thickness larger than the first thickness.

2. The winding of claim 1, wherein the first turn insulation is a braid or serve; and wherein the braid or serve is impregnated with a thermoset resin.

3. The winding of claim 1, wherein the first turn insulation is a fused silica with a purity of at least 99.9%, Alumina, Beryllia, Boron Nitride, or Aluminum Nitride and the first conductor insulation is polyimide or polyether ether ketone based.

4. The winding of claim 1, wherein the electrical winding has a radially inward portion and a radially outward portion, and wherein the first turn extends from the radially inward portion to the radially outward portion.

5. The winding of claim 4, wherein at least one of the first plurality of conductors extends from the radially inward portion to the radially outward portion.

6. The winding of claim 1, wherein a radial heat transfer path through the electrical winding passes through no more than two layers of the first turn insulation.

7. The winding of claim 1, wherein the first plurality of conductors is transposed within the first turn.

8. The winding of claim 1, wherein each of the first plurality of conductors has a diameter; and wherein a ratio of the first thickness to the diameter is within a range of 0.01 to 0.1.

9. The winding of claim 1, wherein the electrical winding has a fill factor of at least 50%.

10. An electrical winding comprising:
a first turn including:
a first turn insulation;
a first plurality of conductors positioned within the first turn insulation; and
a first conductor insulation coupled to each of the first plurality of conductors;
wherein the first conductor insulation has a first thickness, and the first turn insulation has a second thickness larger than the first thickness; and
wherein the first turn insulation is a braid; and wherein the braid is impregnated with a thermoset resin.

11. The winding of claim 10, wherein the first turn insulation is a fused silica with a purity of at least 99.9%, Alumina, Beryllia, Boron Nitride, or Aluminum Nitride.

12. The winding of claim 10, wherein the first turn insulation has a thermal conductivity of at least 1 W/m-K.

13. The winding of claim 12, wherein the first turn insulation has a thermal conductivity of at least 30 W/m-K.

14. The winding of claim 10, wherein the first turn insulation has a dielectric strength less than 4000 V/mil.

15. The winding of claim 14, wherein the first turn insulation has a dielectric strength within a range of 400 V/mil and 500 V/mil.

16. The winding of claim 10, wherein space between the first plurality of conductors positioned within the first turn insulation is impregnated with the thermoset resin.

17. An electrical winding comprising:
a first turn including
a first turn insulation made of a first material;
a first plurality of conductors positioned within the first turn insulation; and
a first conductor insulation coupled to each of the first plurality of conductors, the first conductor insulation made of a second material different than the first material;
wherein the first conductor insulation has a first thickness, and the first turn insulation has a second thickness larger than the first thickness.

18. The winding of claim 17, wherein the first material is a fused silica with a purity of at least 99.9%, Alumina, Beryllia, Boron Nitride, or Aluminum Nitride.

19. The winding of claim 18, wherein the second material is polyimide or polyether ether ketone based.

20. The winding of claim 17, wherein the first conductor insulation is no more than single build.

21. The winding of claim 17, further including a second turn with a second turn insulation and a second plurality of conductors positioned within the second turn insulation; and further including a slot liner, wherein the first turn and the second turn are positioned within the slot liner.

22. The winding of claim 21, wherein the slot liner is polyimide or polyether ether ketone based.

23. The winding of claim 21, wherein the slot liner is a fabric of fibers made of fused silica, Alumina, Beryllia, Boron Nitride, or Aluminum Nitride.

24. An electrical winding comprising:
a slot liner with a first edge and a second edge;
a plurality of turns positioned within the slot liner; the plurality of turns defining an outer perimeter with an air-gap portion;
wherein the first edge is coupled to the second edge at the air-gap portion such that the slot liner surrounds the outer perimeter with a uniform thickness except at the air-gap portion.

25. The winding of claim 24, wherein the air-gap portion is a radially-inward surface of the plurality of turns.

26. The winding of claim 24, wherein the first edge overlaps the second edge and is coupled to the second edge with an adhesive.

27. The winding of claim 24, wherein a dielectric tape couples the first edge to the second edge.

28. The winding of claim 24, wherein the slot liner is polyimide or polyether ether ketone based.

29. The winding of claim 24, wherein the slot liner is a fabric of fibers made of fused silica, Alumina, Beryllia, Boron Nitride, or Aluminum Nitride.

30. The winding of claim 24, wherein the slot liner has a thickness of no more than 20 mil.

31. The winding of claim 24, wherein the winding does not include a slot wedge.
